(19) United States
(12) Patent Application Publication
(10) Pub. No.: US 2023/0230061 A1
(43) Pub. Date: Jul. 20, 2023

(54) SYSTEMS AND METHODS FOR MATCHING TOKENIZED ACCOUNTS BETWEEN ANONYMOUS PARTIES

(71) Applicant: Tapp Holdings, LLC, Atlanta, GA (US)

(72) Inventors: Matthew Creatore, Atlanta, GA (US); Reinaldo Cruz, Brooklyn, NY (US)

(21) Appl. No.: 18/156,844

(22) Filed: Jan. 19, 2023

Related U.S. Application Data
(60) Provisional application No. 63/300,922, filed on Jan. 19, 2022.

(51) Int. Cl. G06Q 20/22; G06Q 20/32; G06Q 20/38; G06Q 20/02; G06Q 20/20

(52) U.S. Cl. CPC G06Q 20/227; G06Q 20/326; G06Q 20/383; G06Q 20/027; G06Q 20/3276; G06Q 20/202; G06Q 30/0238

(57) ABSTRACT

Systems and methods that allow fulfilment of a transaction wherein a first party initiates the transaction, for example, at a point-of-sale device, and a tokenized account of an anonymous second party is identified as an account optimal for completing the transaction. The tokenized account of the anonymous second party is identified based on the transaction information. The tokenized account of the anonymous second party is matched to complete the transaction for reasons including a financial advantage or incentive associated with the tokenized account of the anonymous second party and not available to the first party at the time of the transaction. This financial advantage may be shared between both parties. The tokenized account of the anonymous second party may receive a financial benefit or other valuable consideration for completing the transaction. The tokenized account of the anonymous second party is reimbursed for costs associated with completing the transaction.

### CROSS REFERENCE TO RELATED APPLICATIONS

This application is a Non-Provisional Patent Application of, and claims the benefit of and priority to, U.S. Provisional Patent Application No. 63/300,922, filed on Jan. 19, 2022, and entitled “SYSTEMS AND METHODS FOR MATCHING TOKENIZED ACCOUNTS BETWEEN ANONYMOUS PARTIES,” the disclosure of which is incorporated by reference as if the same were set forth herein in its entirety.

### TECHNICAL FIELD

The present disclosure relates to systems and methods for matching tokenized accounts between anonymous parties, and more specifically to matching one or more tokenized financial accounts, belonging to a first user, to a financial transaction initiated by a second user at a merchant's point-of-sale system in order to allow for the second user to obtain a good or service by using an optimal payment method corresponding to the one or more tokenized financial accounts, and further securely transmitting the first user's payment data associated with the optimal payment method to complete the transaction initiated by the second user.

### BACKGROUND

Typically, the process of a consumer exchanging payment information with a merchant at a point-of-sale involves considerable measures and risk assessments that are aimed to ensure no consumer personal identifiable information (PII), nor financial information is compromised and is securely transmitted only to the parties who are required in facilitating the transaction.

In 2018, $24.26 billion was lost worldwide in relation to credit card fraud. In 2019, there were 271,000 cases of credit card fraud—increasing in excess of 70% year-over-year. This is a sizable cost for card issuing banks and merchants as well as an emotional expense for affected card holders. As a result, financial institutions have placed safety as the highest priority in each of their commercialized payment methods and as they have innovated throughout the 21^{st} century.

The growth of contactless payments has helped these institutions manifest a more secure and less costly environment. EMV-standard technology has decreased counterfeit card fraud by 87 percent, and overall, in-person payment fraud by 40 percent.

Payments typically take place via three primary means: magnetic stripe reader (MSR), quick response (QR) codes, or near field communication (NFC). Each offer differing advantages and disadvantages to the customer and the merchant, but in all cases the consumer's primary account number (PAN), security codes (e.g., card verification value (CVV)) remain protected as they travel between parties no matter if the transaction takes place in a card present (CP) or card not present (CNP) fashion. These communication protocols have allowed financial institutions around the world to minimize both fraudulent activity with enhanced methods of encryption and the disbursements that are frequently made to cover unauthorized purchases on a consumer's credit card. These processes have enabled optimized security by creating faux credit card numbers that can only be decrypted by the appropriate payment parties, using biometric identification (2-factor authentication), sending one-time cryptograms issued by the users mobile device, and removing of physical cards from the payments process that are often misplaced, stolen or easily copied.

Given these enhanced security measures are constant amongst most commonplace payment methods, a consumer's decision on which payment method to use for a particular transaction is oftentimes contingent upon convenience, rewards, benefits, etc. Herein lies where there is considerable variation amongst payment types and causes reason for the consumer to deliberate which to use.

Continued progress associated with incorporating application programming interfaces in the consumer's payment has improved some aspects of the checkout and payment experiences. However, many unresolved needs still remain relating to standardizing the payments process for consumers, integrating NFC and QR technology (as well as other technologies) into payment infrastructures, and ensuring that the consumer uses a payment method in a particular transaction that is unequivocally in their best interest. Therefore, there exists a long-felt but unmet need for systems and methods for matching tokenized accounts between anonymous parties.

### BRIEF SUMMARY OF DISCLOSURE

Aspects of the disclosed systems and methods relate generally to securely exchanging tokenized payment information corresponding to an anonymous user with a merchant's point-of-sale (POS) system (in a physical or virtual environment) for the benefit of a purchaser (User A) using his/her mobile communication device (or another appropriate computer device) to engage in a financial transaction with the POS system. The disclosed systems and methods provide an optimal checkout experience wherein the instantaneous best financial interests of all parties are aligned. The disclosed system may include a software application (referred to herein as “Tapp” or the application, which may be used by the consumer User A to initialize, or participate in, the transmission of transaction data) and the mobile device present at the merchant's POS system which may be used for the purposes of settling a payment due to the merchant. The POS system may operate as a proxy through which the payment data is communicated to or from a merchant's payment checkout server or application to the mobile application. This communication may allow the system to determine which users (for example, User A and User B) from a plurality of users to match with, such that User B's payment details allow User A to maximize the value of his/her payment.

In particular embodiments, system users may connect (or register) their financial accounts with the system to facilitate the exchange of information to appropriate parties. This allows the disclosed system and methods to deliver economic finality in that all involved parties have been vetted prior to transacting to ensure the payment may be fulfilled and settled.

In various embodiments, User B's payment method details may be securely stored within a PCI-compliant token vault which is a secure database maintained within the disclosed system or by a third party who has obtained PCI-DSS certification with respect to the handling of financial information. This token vault may serve as the method's reference, along with other discretionary fields, when exchanging payment details amongst the payment processor endpoints to manifest the payment (for example, via key-value data pairs).

In particular embodiments, User A's connected bank account information need not be held or known by the system. In at least one embodiment, a third party that maintains this information may be operatively connected to an automated clearing house (ACH) partner that orchestrates the debiting and crediting of funds between bank accounts. In various embodiments, the system may transmit specific instructions (for example, an amount of funds to be transferred, and which accounts to transfer the funds between) to the third party and/or the ACH for transferring funds between user and merchant accounts.

In certain embodiments, a purchasing user (User A) may open the herein discussed mobile application on his/her mobile computing device to engage in a financial transaction with a merchant. The user may have the option to select which form of communication is either (1) available to them and configured for use at a particular merchant or (2) that they would prefer to use should multiple payment methods exist as they complete their payment through the application. In one embodiment, in response to initiating or engaging in the payment (or financial transaction), User A and the financial transaction may be matched with an optimal payment method (associated with the User B). Parameters or determining a match may include, but are not limited to, the locations of the users, the transaction value, benefits or incentives offered, platform usage, user credit reliability, predefined user financial goals, etc.

In various embodiments, once the appropriate payment method is determined and User B is matched with User A, a token (for example, an alphanumeric digital representation of certain information, such as encrypted data) may be used to instruct the PCI-compliant third-party database (or a proprietary token database maintained within the disclosed system) through the use of APIs as to the specific payment information to transmit to the merchant's payment system so that the merchant's acquiring bank can settle User A's transaction through the appropriate payment channels. This process may ultimately charge User B's matched payment method and return an authorization message thus completing the transaction. Upon success, the method may debit User A's connected bank account through the use of partner API integrations with the amount owed to User B.

The disclosed systems and methods provide a plurality of advantages over preexisting systems. For example, zero or low interest rate credit is oftentimes under-utilized relative to the maximum allocation provided to a lendee. In certain circumstances, instead of leveraging one's own credit line(s)—if even available to a purchaser—it may be beneficial to leverage another person's financial asset that carries alternative advantages. Further, it incentivizes a migration to a cashless society which ultimately corresponds to less theft, improved public health and enhanced financial security.

For exemplary purposes, consider an example in which User A is registered with the disclosed system and is paying for a meal at a restaurant with his/her credit card which provides a 1% cash back reward on all purchases. In response to User A initiating payment with his/her credit card (and either paying directly with the Tapp application or otherwise allowing for the Tapp system to integrate with User A's payment method), the system (e.g., the user's device, or the POS system) may transmit information including transaction details, POS device identification, tokenized account data relating to User A's account and/or credit card, etc., to a server including at least one or more processors and a specific database configured to store tokenized financial account information. In various embodiments, the server may execute a series of processes (discussed in greater detail below) in which aspects of the received information (e.g., transaction details, User A's tokenized account data, etc.) are compared to aspects of one or more other tokenized accounts stored in the database. According to various aspects of the present disclosure, if the system determines that another registered user, for example, User B, has a credit card account registered within the system (e.g., is represented in the token database) and User B's account provides an incentive more valuable than User A's available 1% cash back reward (for example, a 3% cash back reward), the system may match User B's tokenized account with User A's transaction, such that User B's registered financial account is used to complete User A's transaction (and thus an additional 2% cash back is realized on the transaction). In various embodiments, the system may be configured to automatically reimburse User B via an account associated with User A, such that User B does not carry the cost of User A's transaction. In certain embodiments, the system may include predetermined rules for determining incentive structures and reward-splitting on transactions for which an anonymous user's tokenized account was used to complete another user's transaction. Referring to the example discussed above, the system may determine that the additional 2% cash back realized on User A's transaction be split equally between User A and User B. In other embodiments, users may establish their own terms regarding how rewards earned using their registered accounts are to be distributed between the involved parties.

In particular embodiments, the user may connect a payment method to enable use by other purchasing users (e.g., matching with other users' transaction) by uploading payment details such as the credit or debit card account number and the associated CVV, which may be uploaded via the mobile application interface (accessed via a mobile communication device). IN one embodiment, the payment details may be securely transmitted via API through to a PCI-compliant token vault, owned by a Token Service Provider (TSP), to be stored. For sake of context, examples of companies that provide token services that may be used to complete this method include, but are not limited to, Spreedly, Sequent, Plaid, Focus, EPX, HST, Visa, etc. In some embodiments, the token vault may also be proprietary and maintained within the disclosed system.

In various embodiments, the system includes one or more tokens (unique alphanumeric strings, which are typically encrypted) which may be passed to the appropriate payment parties that require a reference to the payment information but do not intend to incur the security or PCI compliance liability involved with storing this information within the payment party's infrastructure. This unique tokenized representation may be stored by the payment party in their application database. In the end, this may allow the payment party to have a digital representation to pass to the token vault endpoint when the matching method specifies it to be used for purchase based on user preferences and configurations. The user may also opt to connect their other bank, brokerage, checking, savings, or otherwise, accounts to the application to be used as a form of payment in the event of a purchase. Such connection may be used at the end of the transaction to ensure that funds are remitted back to the user providing the method of payment used at the point-of-sale.

In one embodiment, this system may be initiated by a consuming user once they are located, physically or virtually, at a merchant's POS checkout kiosk or application respectively. In some cases, authentication may be required for security purposes such as biometric authentication and once successful the user may choose between two methods of communications contingent upon (1) which method is available and configured for their use at a particular merchant or (2) their preference should multiple payment methods exist as they complete their payment through the application. This method may also be uniquely initiated via wearables, device insertions, device implants, or a card unique to this process which contains an ISO/IEC 14443 EMV chip (or the like).

In certain embodiments, these unique method initiation techniques may operate in coordination with other devices or user interactions for the benefit of security or otherwise in order to display more information about the transactions so that the associate parties can come to a more informed decision for the sake of manifest the objective of this method. The information displayed may be captured in a physical, augmented, or virtual space. The method discussed herein may operate regardless of the medium through which information travels, is exchanged or is displayed and is in no way limited to the communication mechanisms available at the time of filing.

In one embodiment, should the user choose Near Field Communication (NFC) and as prompted, hold their device within a few centimeters of the merchant's payment terminal, data may be transmitted via magnetic pulses through a mobile device's secure element in line with near field communication protocols and EMVCo. standards at a merchant's point-of-sale.

The disclosed system, via the mobile application at the user's device (e.g., the Tapp application) may collect data via proprietary web service application programming interface (API) integrations with payment facilitating parties and other partners including the following but not limited to: the POS terminal device, POS application, and POS gateway, networks (e.g., social networks, payment networks, etc.), or processing parties. Remaining data such as allocated tip percentage, etc., may be collected from the user through mechanisms such as but not limited to the POS terminal kiosk that the consumer interfaces with during the payment or the user's own mobile device interface depending on the payment routes enabled by the merchant's software POS components and configurations. If no merchant data is collected when the near field communication antenna is activated, the method may either pass User A's own payment information through to cover the charge or return a payment error response depending on the predefined user's settings within the application. In certain embodiments, User A may be matched with their own line of credit if the method's algorithm deems that it would be most advantageous to the user as described later in this disclosure.

In various embodiments, the user may also opt to scan a quick response code with the user's mobile device's camera interface generated by the merchant's POS application and displayed on a merchant's paper receipt or kiosk interface to make a payment. In one embodiment, scanning the QR code (which contain a data payload typically expressed in JSON format) initiates the payment process by redirecting the consumer to the application that may handle the completion of the payment. In certain embodiments, the user's mobile device may generate the QR code and either display the QR Code on a screen at the mobile device, or the mobile device may wirelessly transmit the QR Code information to the merchant, to be displayed/represented by the merchant and scanned/detected (or otherwise electronically recognized or captured) by the user's mobile device.

In at least one embodiment, scanning a QR code may trigger integrations that provide direction for associated payment party applications to share or exchange details related to the transaction such as transaction amount, merchant name, merchant location, merchant category, purchased good(s) or service(s), etc., allowing consuming users to access more value-added services at the point of sale. In particular embodiments, these dynamic QR codes, which change as the contents or parameters of the message contained therein change, specifically allow the user's mobile device to become a proxy through which the user can provide transaction specific data to an application through one simple scan. Moreover, regardless of the chosen communication method, the process allows for the exchange of data including but not limited to transaction amount, tip (if captured within the merchant's POS terminal interface), description, products (goods or services), merchant name, location, timezone, etc., which is exchanged between the mobile application and the merchant's point of sale system.

In certain embodiments, as a result, the cardholding user's correct payment token from the database may be passed with TSP required fields to the Token Service Provider (TSP), which may then access the corresponding PAN from the PCI-compliant card vault. The TSP may then transmit an encrypted, secure message with such payment information to the payment network (e.g., Visa, Mastercard, etc.). Then, based on the bank identification number (BIN) table, the payment network may transmit the transaction information, PAN and CVV (security code) to the card issuing financial institution which may test if the provided security code matches the CVV corresponding to that particular PAN. If the information is determined to match, the issuing financial institution may provide an authorization notice/message to the payment network, or to the herein disclosed system, which may ultimately complete transaction by notifying the merchant's POS application of success and capture, settling the transaction.

In one embodiment, the present disclosure discusses a method including the steps of: receiving, at a processor at a remote financial transaction matching system, transaction data from a mobile computing device, the mobile computing device running an application and transmitting the transaction data to the remote computing system in response to an application user engaging in a financial transaction with a point of sale system associated with a merchant, wherein the transaction data includes at least an application user identifier, a merchant identifier, and transaction details, and wherein the transaction data is generated via the mobile computing device in response to the mobile computing device detecting a machine-readable code proffered by the point of sale system, the machine-readable code including an encoded representation of at least the merchant identifier and the transaction details; determining, from a plurality of financial accounts stored in a database at the remote computing system and wherein each financial account of the plurality of financial accounts is associated with a respective pseudo-anonymous system user, a particular optimal financial account to fulfill the financial transaction, wherein the particular optimal financial account is determined based at least on one or more transaction incentives applicable to the financial transaction and available for use via the particular optimal financial account; determining a unique account identifier corresponding to the particular optimal financial account, wherein the unique account identifier is stored in the database in association with the particular optimal financial account; determining, via processing the unique account identifier and modified transaction data at an authorization gateway, that the particular optimal financial account is authorized to fulfill the financial transaction; in response to determining that the particular optimal financial account is authorized to fulfill the financial transaction, transmitting a transaction approval notice to the point of sale system; and initiating, via transmitting a request to one or more financial institutions responsible for facilitating payments with the particular optimal financial account, a charge to a legitimate account number corresponding to particular optimal financial account for a particular monetary amount to complete the financial transaction with the merchant.

In various embodiments, the request to the one or more financial institutions includes instructions for the particular monetary amount to be routed to a merchant banking account. In particular embodiments, the methods further includes the steps of: retrieving, from the database, an encrypted asset account identifier stored in association with the application user identifier; retrieving, from the database, an encrypted asset account identifier stored in association with the particular optimal financial account; decrypting (1) the encrypted asset account identifier stored in association with the application user identifier to determine account and routing information corresponding to an asset account belonging to the application user, and (2) the encrypted asset account identifier stored in association with the particular optimal financial account to determine account and routing information corresponding to an asset account belonging to a particular pseudo-anonymous system user associated with the particular optimal financial account; and transmitting a request to the asset account belonging to the application user, wherein the request includes instructions for initiating a transfer of a particular value amount owed to be transferred from the asset account belonging to the application user to the asset account belonging to the particular pseudo-anonymous system user, and wherein the particular value amount owed constitutes reimbursement for the application user's use of the particular optimal financial account.

In at least one embodiment, the particular value amount owed to the asset account belonging to the particular pseudo-anonymous system user includes a value less than the particular monetary amount to complete the financial transaction with the merchant, wherein the difference includes a predetermined percentage of a value corresponding to the one or more transaction incentives. In various embodiments, the unique account identifier associated with the particular optimal financial account includes a tokenized representation of its legitimate account number. Moreover, in at least one embodiment, the encrypted asset account identifier associated with the particular optimal financial account, and the encrypted asset account identifier associated with the application user identifier, each include tokenized representations of the account and routing information corresponding to their respective asset accounts. In certain embodiments, the machine-readable code proffered by the point of sale system includes a QR code or a near field communication transmission.

According to various aspects of the present disclosure, prior to determining the particular optimal financial account, the method further includes the step of receiving, in response to the application user interacting with an application graphical user interface displayed on the mobile computing device, one or more application user repayment preferences, wherein the one or more application user repayment preferences include repayment terms including repayment date, repayment installments, applicable interest rates, and acceptable asset types.

In one embodiment, the present disclosure discusses a system a remote financial transaction matching system including a processor and a database, wherein the processor is operatively configured to execute the steps including: receiving, at a processor at a remote financial transaction matching system, transaction data from a mobile computing device, the mobile computing device running an application and transmitting the transaction data to the remote computing system in response to an application user engaging in a financial transaction with a point of sale system associated with a merchant, wherein the transaction data includes at least an application user identifier, a merchant identifier, and transaction details, and wherein the transaction data is generated via the mobile computing device in response to the mobile computing device detecting a machine-readable code proffered by the point of sale system, the machine-readable code including an encoded representation of at least the merchant identifier and the transaction details; determining, from a plurality of financial accounts stored in a database at the remote computing system and wherein each financial account of the plurality of financial accounts is associated with a respective pseudo-anonymous system user, a particular optimal financial account to fulfill the financial transaction, wherein the particular optimal financial account is determined based at least on one or more transaction incentives applicable to the financial transaction and available for use via the particular optimal financial account; determining a unique account identifier corresponding to the particular optimal financial account, wherein the unique account identifier is stored in the database in association with the particular optimal financial account; determining, via processing the unique account identifier and modified transaction data at an authorization gateway, that the particular optimal financial account is authorized to fulfill the financial transaction; in response to determining that the particular optimal financial account is authorized to fulfill the financial transaction, transmitting a transaction approval notice to the point of sale system; and initiating, via transmitting a request to one or more financial institutions responsible for facilitating payments with the particular optimal financial account, a charge to a legitimate account number corresponding to particular optimal financial account for a particular monetary amount to complete the financial transaction with the merchant.

In various embodiments, the request to the one or more financial institutions includes instructions for the particular monetary amount to be routed to a merchant banking account. In certain embodiments, the processor is further operatively configured to execute the steps including: retrieving, from the database, an encrypted asset account identifier stored in association with the application user identifier; retrieving, from the database, an encrypted asset account identifier stored in association with the particular optimal financial account; decrypting (1) the encrypted asset account identifier stored in association with the application user identifier to determine account and routing information corresponding to an asset account belonging to the application user, and (2) the encrypted asset account identifier stored in association with the particular optimal financial account to determine account and routing information corresponding to an asset account belonging to a particular pseudo-anonymous system user associated with the particular optimal financial account; and transmitting a request to the asset account belonging to the application user, wherein the request includes instructions for initiating a transfer of a particular value amount owed to be transferred from the asset account belonging to the application user to the asset account belonging to the particular pseudo-anonymous system user, and wherein the particular value amount owed constitutes reimbursement for the application user's use of the particular optimal financial account.

In various embodiments, the particular value amount owed to the asset account belonging to the particular pseudo-anonymous system user includes a value less than the particular monetary amount to complete the financial transaction with the merchant, wherein the difference includes a predetermined percentage of a value corresponding to the one or more transaction incentives. In at least one embodiment, the unique account identifier associated with the particular optimal financial account includes a tokenized representation of its legitimate account number. In certain embodiments, the encrypted asset account identifier associated with the particular optimal financial account, and the encrypted asset account identifier associated with the application user identifier, each include tokenized representations of the account and routing information corresponding to their respective asset accounts. In a particular embodiment, the machine-readable code proffered by the point of sale system includes a QR code or a near field communication transmission.

According to various aspects of the present disclosure, prior to determining the particular optimal financial account, the processor is further operatively configured to execute the steps including receiving, in response to the application user interacting with an application graphical user interface displayed on the mobile computing device, one or more application user repayment preferences, wherein the one or more application user repayment preferences include repayment terms including repayment date, repayment installments, applicable interest rates, and acceptable asset types.

In one embodiment, the present disclosure discusses a tangible, non-transitory, computer-readable medium including instructions encoded therein, wherein the instructions, when executed by one or more processors, cause the one or more processors to execute the steps including: receiving, at a processor at a remote financial transaction matching system, transaction data from a mobile computing device, the mobile computing device running an application and transmitting the transaction data to the remote computing system in response to an application user engaging in a financial transaction with a point of sale system associated with a merchant, wherein the transaction data includes at least an application user identifier, a merchant identifier, and transaction details, and wherein the transaction data is generated via the mobile computing device in response to the mobile computing device detecting a machine-readable code proffered by the point of sale system, the machine-readable code including an encoded representation of at least the merchant identifier and the transaction details; determining, from a plurality of financial accounts stored in a database at the remote computing system and wherein each financial account of the plurality of financial accounts is associated with a respective pseudo-anonymous system user, a particular optimal financial account to fulfill the financial transaction, wherein the particular optimal financial account is determined based at least on one or more transaction incentives applicable to the financial transaction and available for use via the particular optimal financial account; determining a unique account identifier corresponding to the particular optimal financial account, wherein the unique account identifier is stored in the database in association with the particular optimal financial account; determining, via processing the unique account identifier and modified transaction data at an authorization gateway, that the particular optimal financial account is authorized to fulfill the financial transaction; in response to determining that the particular optimal financial account is authorized to fulfill the financial transaction, transmitting a transaction approval notice to the point of sale system; and initiating, via transmitting a request to one or more financial institutions responsible for facilitating payments with the particular optimal financial account, a charge to a legitimate account number corresponding to particular optimal financial account for a particular monetary amount to complete the financial transaction with the merchant.

In at least one embodiment, the instructions, when executed by one or more processors, further cause the one or more processors to execute the steps including: retrieving, from the database, an encrypted asset account identifier stored in association with the application user identifier; retrieving, from the database, an encrypted asset account identifier stored in association with the particular optimal financial account; decrypting (1) the encrypted asset account identifier stored in association with the application user identifier to determine account and routing information corresponding to an asset account belonging to the application user, and (2) the encrypted asset account identifier stored in association with the particular optimal financial account to determine account and routing information corresponding to an asset account belonging to a particular pseudo-anonymous system user associated with the particular optimal financial account; and transmitting a request to the asset account belonging to the application user, wherein the request includes instructions for initiating a transfer of a particular value amount owed to be transferred from the asset account belonging to the application user to the asset account belonging to the particular pseudo-anonymous system user, and wherein the particular value amount owed constitutes reimbursement for the application user's use of the particular optimal financial account.

In certain embodiments, the particular value amount owed to the asset account belonging to the particular pseudo-anonymous system user includes a value less than the particular monetary amount to complete the financial transaction with the merchant, wherein the difference includes a predetermined percentage of a value corresponding to the one or more transaction incentives.

According to various aspects of the present disclosure, prior to determining the particular optimal financial account, the instructions, when executed by one or more processors, further cause the one or more processors to execute the steps including receiving, in response to the application user interacting with an application graphical user interface displayed on the mobile computing device, one or more application user repayment preferences, wherein the one or more application user repayment preferences include repayment terms including repayment date, repayment installments, applicable interest rates, and acceptable asset types.

These and other aspects, features, and benefits of the claimed embodiment(s) will become apparent from the following detailed written description of the embodiments and aspects taken in conjunction with the following drawings, although variations and modifications thereto may be effected without departing from the spirit and scope of the novel concepts of the disclosure.

### BRIEF DESCRIPTION OF DRAWINGS

Embodiments of methods, devices, and systems are illustrated in the figures of the accompanying drawings which are meant to be exemplary and not limiting, in which like references are intended to refer to corresponding or like parts, and in which:

FIG. 1 is a diagram of an exemplary system configuration, according to one embodiment of the present disclosure;

FIG. 2 is a flowchart of an exemplary system process, according to one embodiment of the present disclosure;

FIG. 3 is a flowchart of an exemplary general matching process, according to one embodiment of the present disclosure;

FIG. 4 is a flowchart of a preliminary matching process, according to one embodiment of the present disclosure;

FIG. 5 is a flowchart of an exemplary account-type matching process, according to one embodiment of the present disclosure;

FIG. 6 is a flowchart of an exemplary account matching process, according to one embodiment of the present disclosure;

FIG. 7 is a flowchart of an exemplary account authorization process, according to one embodiment of the present disclosure; and

FIG. 8 is a flowchart of an exemplary account settlement process, according to one embodiment of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims. The disclosure includes detailed embodiments of the systems and methods involved in the proprietary process described herein, however, it should understood that there are no limitations placed on this disclosure or examples used. The exemplary information captured simply serves as a means to represent or depict the claims in various forms so that they are more easily understood.

### Overview

Aspects of the disclosed systems and methods relate generally to securely exchanging tokenized payment information corresponding to an anonymous user with a merchant's point-of-sale (POS) system (in a physical or virtual environment) for the benefit of a purchaser (User A) using his/her mobile communication device (or another appropriate computer device) to engage in a financial transaction with the POS system. The disclosed systems and methods provide an optimal checkout experience wherein the instantaneous best financial interests of all parties are aligned. The disclosed system may include a software application (referred to herein as “Tapp” or the application, which may be used by the consumer User A to initialize, or participate in, the transmission of transaction data) and the mobile device present at the merchant's POS system which may be used for the purposes of settling a payment due to the merchant. The POS system may operate as a proxy through which the payment data is communicated to or from a merchant's payment checkout server or application to the mobile application. This communication may allow the system to determine which users (for example, User A and User B) from a plurality of users to match with, such that User B's payment details allow User A to maximize the value of his/her payment.

In particular embodiments, system users may connect (or register) their financial accounts with the system to facilitate the exchange of information to appropriate parties. This allows the disclosed system and methods to deliver economic finality in that all involved parties have been vetted prior to transacting to ensure the payment may be fulfilled and settled.

In various embodiments, User B's payment method details may be securely stored within a PCI-compliant token vault which is a secure database maintained within the disclosed system or by a third party who has obtained PCI-DSS certification with respect to the handling of financial information. This token vault may serve as the method's reference, along with other discretionary fields, when exchanging payment details amongst the payment processor endpoints to manifest the payment (for example, via key-value data pairs).

In particular embodiments, User A's connected bank account information need not be held or known by the system. In at least one embodiment, a third party that maintains this information may be operatively connected to an automated clearing house (ACH) partner that orchestrates the debiting and crediting of funds between bank accounts. In various embodiments, the system may transmit specific instructions (for example, an amount of funds to be transferred, and which accounts to transfer the funds between) to the third party and/or the ACH for transferring funds between user and merchant accounts.

In certain embodiments, a purchasing user (User A) may open the herein discussed mobile application on his/her mobile computing device to engage in a financial transaction with a merchant. The user may have the option to select which form of communication is either (1) available to them and configured for use at a particular merchant or (2) that they would prefer to use should multiple payment methods exist as they complete their payment through the application. In one embodiment, in response to initiating or engaging in the payment (or financial transaction), User A and the financial transaction may be matched with an optimal payment method (associated with the User B). Parameters or determining a match may include, but are not limited to, the locations of the users, the transaction value, benefits or incentives offered, platform usage, user credit reliability, predefined user financial goals, etc.

In various embodiments, once the appropriate payment method is determined and User B is matched with User A, a token (for example, an alphanumeric digital representation of certain information, such as encrypted data) may be used to instruct the PCI-compliant third-party database (or a proprietary token database maintained within the disclosed system) through the use of APIs as to the specific payment information to transmit to the merchant's payment system so that the merchant's acquiring bank can settle User A's transaction through the appropriate payment channels. This process may ultimately charge User B's matched payment method and return an authorization message thus completing the transaction. Upon success, the method may debit User A's connected bank account through the use of partner API integrations with the amount owed to User B.

The disclosed systems and methods provide a plurality of advantages over preexisting systems. For example, zero or low interest rate credit is oftentimes under-utilized relative to the maximum allocation provided to a lendee. In certain circumstances, instead of leveraging one's own credit line(s)—if even available to a purchaser—it may be beneficial to leverage another person's financial asset that carries alternative advantages. Further, it incentivizes a migration to a cashless society which ultimately corresponds to less theft, improved public health and enhanced financial security.

For exemplary purposes, consider an example in which User A is registered with the disclosed system and is paying for a meal at a restaurant with his/her credit card which provides a 1% cash back reward on all purchases. In response to User A initiating payment with his/her credit card (and either paying directly with the Tapp application or otherwise allowing for the Tapp system to integrate with User A's payment method), the system (e.g., the user's device, or the POS system) may transmit information including transaction details, POS device identification, tokenized account data relating to User A's account and/or credit card, etc., to a server including at least one or more processors and a specific database configured to store tokenized financial account information. In various embodiments, the server may execute a series of processes (discussed in greater detail below) in which aspects of the received information (e.g., transaction details, User A's tokenized account data, etc.) are compared to aspects of one or more other tokenized accounts stored in the database. According to various aspects of the present disclosure, if the system determines that another registered user, for example, User B, has a credit card account registered within the system (e.g., is represented in the token database) and User B's account provides an incentive more valuable than User A's available 1% cash back reward (for example, a 3% cash back reward), the system may match User B's tokenized account with User A's transaction, such that User B's registered financial account is used to complete User A's transaction (and thus an additional 2% cash back is realized on the transaction). In various embodiments, the system may be configured to automatically reimburse User B via an account associated with User A, such that User B does not carry the cost of User A's transaction. In certain embodiments, the system may include predetermined rules for determining incentive structures and reward-splitting on transactions for which an anonymous user's tokenized account was used to complete another user's transaction. Referring to the example discussed above, the system may determine that the additional 2% cash back realized on User A's transaction be split equally between User A and User B. In other embodiments, users may establish their own terms regarding how rewards earned using their registered accounts are to be distributed between the involved parties.

In particular embodiments, the user may connect a payment method to enable use by other purchasing users (e.g., matching with other users' transaction) by uploading payment details such as the credit or debit card account number and the associated CVV, which may be uploaded via the mobile application interface (accessed via a mobile communication device). IN one embodiment, the payment details may be securely transmitted via API through to a PCI-compliant token vault, owned by a Token Service Provider (TSP), to be stored. For sake of context, examples of companies that provide token services that may be used to complete this method include, but are not limited to, Spreedly, Sequent, Plaid, Focus, EPX, HST, Visa, etc. In some embodiments, the token vault may also be proprietary and maintained within the disclosed system.

In various embodiments, the system includes one or more tokens (unique alphanumeric strings, which are typically encrypted) which may be passed to the appropriate payment parties that require a reference to the payment information but do not intend to incur the security or PCI compliance liability involved with storing this information within the payment party's infrastructure. This unique tokenized representation may be stored by the payment party in their application database. In the end, this may allow the payment party to have a digital representation to pass to the token vault endpoint when the matching method specifies it to be used for purchase based on user preferences and configurations. The user may also opt to connect their other bank, brokerage, checking, savings, or otherwise, accounts to the application to be used as a form of payment in the event of a purchase. Such connection may be used at the end of the transaction to ensure that funds are remitted back to the user providing the method of payment used at the point-of-sale.

In one embodiment, this system may be initiated by a consuming user once they are located, physically or virtually, at a merchant's POS checkout kiosk or application respectively. In some cases, authentication may be required for security purposes such as biometric authentication and once successful the user may choose between two methods of communications contingent upon (1) which method is available and configured for their use at a particular merchant or (2) their preference should multiple payment methods exist as they complete their payment through the application. This method may also be uniquely initiated via wearables, device insertions, device implants, or a card unique to this process which contains an ISO/IEC 14443 EMV chip (or the like).

In certain embodiments, these unique method initiation techniques may operate in coordination with other devices or user interactions for the benefit of security or otherwise in order to display more information about the transactions so that the associate parties can come to a more informed decision for the sake of manifest the objective of this method. The information displayed may be captured in a physical, augmented, or virtual space. The method discussed herein may operate regardless of the medium through which information travels, is exchanged or is displayed and is in no way limited to the communication mechanisms available at the time of filing.

In one embodiment, should the user choose Near Field Communication (NFC) and as prompted, hold their device within a few centimeters of the merchant's payment terminal, data may be transmitted via magnetic pulses through a mobile device's secure element in line with near field communication protocols and EMVCo. standards at a merchant's point-of-sale.

The disclosed system, via the mobile application at the user's device (e.g., the Tapp application) may collect data via proprietary web service application programming interface (API) integrations with payment facilitating parties and other partners including the following but not limited to: the POS terminal device, POS application, and POS gateway, networks (e.g., social networks, payment networks, etc.), or processing parties. Remaining data such as allocated tip percentage, etc., may be collected from the user through mechanisms such as but not limited to the POS terminal kiosk that the consumer interfaces with during the payment or the user's own mobile device interface depending on the payment routes enabled by the merchant's software POS components and configurations. If no merchant data is collected when the near field communication antenna is activated, the method may either pass User A's own payment information through to cover the charge or return a payment error response depending on the predefined user's settings within the application. In certain embodiments, User A may be matched with their own line of credit if the method's algorithm deems that it would be most advantageous to the user as described later in this disclosure.

In various embodiments, the user may also opt to scan a quick response code with the user's mobile device's camera interface generated by the merchant's POS application and displayed on a merchant's paper receipt or kiosk interface to make a payment. In one embodiment, scanning the QR code (which contain a data payload typically expressed in JSON format) initiates the payment process by redirecting the consumer to the application that may handle the completion of the payment. In certain embodiments, the user's mobile device may generate the QR code and either display the QR Code on a screen at the mobile device, or the mobile device may wirelessly transmit the QR Code information to the merchant, to be displayed/represented by the merchant and scanned/detected (or otherwise electronically recognized or captured) by the user's mobile device.

In at least one embodiment, scanning a QR code may trigger integrations that provide direction for associated payment party applications to share or exchange details related to the transaction such as transaction amount, merchant name, merchant location, merchant category, purchased good(s) or service(s), etc., allowing consuming users to access more value-added services at the point of sale. In particular embodiments, these dynamic QR codes, which change as the contents or parameters of the message contained therein change, specifically allow the user's mobile device to become a proxy through which the user can provide transaction specific data to an application through one simple scan. Moreover, regardless of the chosen communication method, the process allows for the exchange of data including but not limited to transaction amount, tip (if captured within the merchant's POS terminal interface), description, products (goods or services), merchant name, location, timezone, etc., which is exchanged between the mobile application and the merchant's point of sale system.

In certain embodiments, as a result, the cardholding user's correct payment token from the database may be passed with TSP required fields to the Token Service Provider (TSP), which may then access the corresponding PAN from the PCI-compliant card vault. The TSP may then transmit an encrypted, secure message with such payment information to the payment network (e.g., Visa, Mastercard, etc.). Then, based on the bank identification number (BIN) table, the payment network may transmit the transaction information, PAN and CVV (security code) to the card issuing financial institution which may test if the provided security code matches the CVV corresponding to that particular PAN. If the information is determined to match, the issuing financial institution may provide an authorization notice/message to the payment network, or to the herein disclosed system, which may ultimately complete transaction by notifying the merchant's POS application of success and capture, settling the transaction.

### Exemplary Embodiments

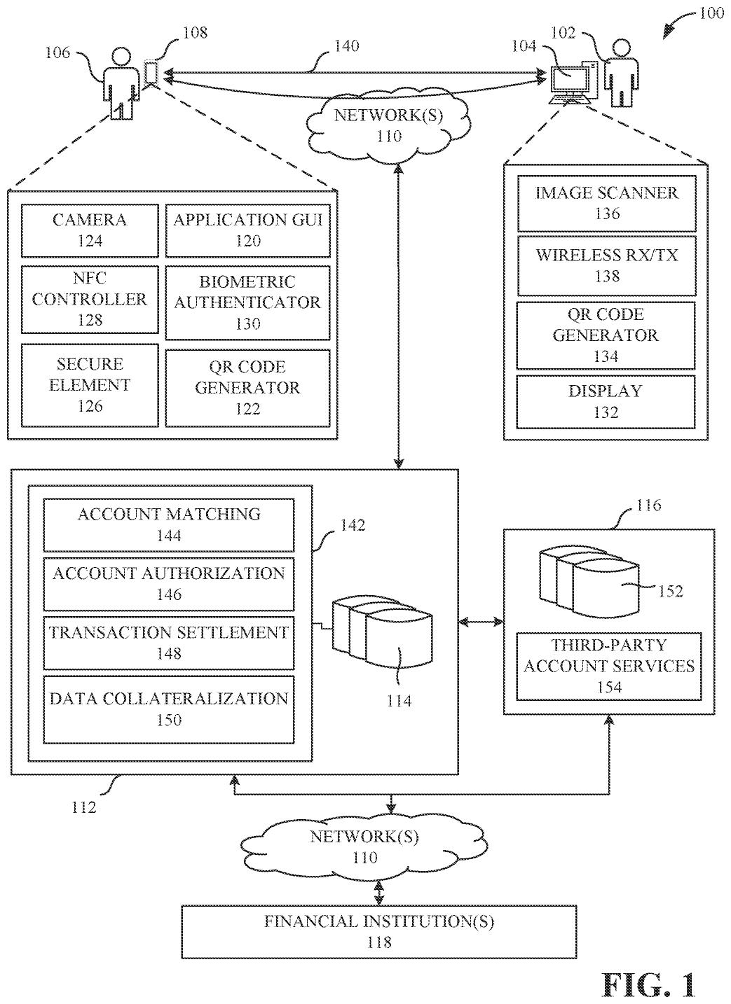

Referring now to the drawings, FIG. 1 is an exemplary system operational environment 100, according to one embodiment. In particular embodiments, the system illustrated in the operational environment 100 orchestrates a process through which payment information of two matched financial accounts can be stored, digitally represented, exchanged, captured, and processed with the objective of authorizing, capturing and completing a transaction insofar as the benefit gained by each party involved in the payment is optimized. As illustrated in FIG. 1, the operational environment 100 includes at least a merchant 102 with a merchant point-of-sale computing device 104 (POS device 104, or POS system 104) and a user 106 with a mobile computing device 108. In one embodiment, the merchant 102 may be a brick-and-mortar merchant such as a grocery store or restaurant, or the merchant 102 may be a virtual storefront such as a website (or the like). In various embodiments, the user's mobile computing device 108 and the merchant's POS device 104 may communicate over one or more networks 110.

In one embodiment, the financial account matching processes discussed herein typically involve the user 106 downloading onto his/her mobile computing device 108 a mobile application, wherein the mobile application allows for the user 106 to control various aspects of the account matching processes. As will be discussed in greater detail below, the process of matching financial accounts may be executed at a remote system 112 (or remote account matching system 112) in response to receiving at least transaction information/details from mobile computing device 108 and/or the POS device 104 over the network 110. According to various aspects of the present disclosure, the remote system 112 includes one or more databases 114 for securely storing encrypted account information (tokens) associated with each system user (such as the user 106). In particular embodiments, the remote system 112 is operatively connected to a third-party financial account services system 116, and the remote system 112 may outsource certain tasks to the third-party financial account services system 116, such as storing financial account information in accordance with PCI-compliant standards or executing account and transaction authorization requests. As will be discussed in greater detail below, both the remote system 112 and the third-party financial account services system 116 are operatively connected to one or more financial institutions 118 over the network 110. According to various embodiments, the financial institutions 118 may include banks (e.g., JPMorgan Chase, Wells Fargo, etc.), credit card issuing companies (e.g., Visa, Mastercard, American Express, etc.), automatic clearing houses (ACHs), bank integrators like Plaid, payment authentication gateways like Spreedly, and any other appropriate institutions along the financial payments pipeline.

In at least one embodiment, the user's mobile computing device 108 may include various non-generic computing components and applications for executing the financial transactions discussed herein. In particular, the mobile computing device 108 may include at least a mobile application graphical user interface (GUI) 120, a QR code generator 122, a camera 124, a secure element 126, a near field communication (NFC) controller 128, a biometric authenticator 130, and other similar non-generic computing components and applications.

According to various aspects of the present disclosure, financial transaction information may be communicated between the mobile computing device 108 and the POS device 104 via images such as QR codes. Accordingly, the mobile computing device 108 may include a QR code generator 122 for generating visual. representations of digital transaction information. In particular embodiments, the mobile computing device may further include a display screen on which the QR code may be presented. In certain embodiments where the POS displays a QR code or similar image representative of the transaction details, the mobile computing device 108 further includes a camera 124 for capturing the QR code (or similar imagine) from the POS display.

Moreover, in various embodiments, the mobile computing device 108 includes a biometric authenticator. According to various aspects of the present disclosure, the user 106 may only be permitted to use the mobile application, via the application GUI 120, if the system determines that the person purporting to be the user is indeed the user. in one embodiment, such verification may be accomplished via the biometric authenticator 130. In at least one embodiment, the user 106 may scan a fingerprint, scan an iris (or any appropriate part of the eye), take a picture or video of himself/herself, etc., to be processed by the biometric authenticator 130 and verified for engaging in financial transactions via the system.

Still referring to FIG. 1, the P05 device 104 may include at least a display 132, a QR code generator 134, an image scanner 136, and wireless receiving and transmitting (RX/TX) components 138. According to various aspects of the present disclosure, the display may include a computer screen or monitor attached to the P05 device 104, or the display 132 may be separate from, but operatively connected to, the POS device 104. in at least one embodiment, the QR code generator 134 at the P05 device 104 may be similar to the QR. code generator 122 at the mobile computing device 108 in that both QR code generators 134 and 122 are operatively configured to generate visual machine-readable codes representative of the information such as the financial transaction information. in various embodiments, the display 132 at the P05 device 104 may receive a QR code (or similar code) representative of a financial transaction with the user from the QR code generator 134 to present on the display 132. According to various embodiments, in response to presenting a QR code on the display 132, the user 106 may scan the QR code presented on the display 132 with a camera 124 at the user's mobile computing device 108. In at least one embodiment, this engagement between the user device 108 and the POS system 104 is illustrated at 140 (in only one non-limiting example), which indicates the direct nature in which the user device 108 and the POS system 104 transmit information. in certain embodiments in which the user's mobile computing device 108 generates a QR code (via the QR code generator 122) and presented the QR code on a device display, the merchant POS system 104 may scan the QR code from the device 108 via the POS system's 104 image scanner 136.

According to various aspects of the present disclosure, the wireless receivers and transmitters (RX/IX) 138 at the merchant P08 system 104 further allow for the merchant P08 system 104 to communicate financial transaction information with the user's mobile computing device 108 using communication techniques and protocols such as near field communication (NFC) and the like. For example, in at least one embodiment, the merchant POS system 104 may communicate transaction information with the user's mobile computing device 108 via NFC, where the P08 system 104 may outwardly transmit or broadcast a NFC message corresponding to the financial transaction between the merchant and the user, and the mobile computing device 108 may receive the NFC message in response to the user positioning the mobile computing device 108 in close proximity to the POS device 104 such that a computing device such as the secure element 126 or the NFC controller 128 may receive the NFC message.

In various embodiments, a remote processor 142 at the remote account matching system 112 is operatively configured to execute processes including account matching 144, account authorization 146, transaction settlement 148, and data collateralization 150, each of which will be discussed in greater detail herein. Moreover, the remote processor 142 at the remote account matching system 112 may be operatively connected to one or more databases 114. In at least one embodiment, the one or more databases 114 include nonrelational databases (and databases of other formats, such as relational databases) for storing financial account names in association with tokens encrypted identifiers) corresponding to the accounts. In various embodiments, the financial accounts names and associated tokens are generally stored in a key-value pair format, where the financial account name may be the key, and the corresponding value may be the account token.

In particular embodiments, the account token may be generated by the third-party financial account services system 116, and the account token may include encrypted account information securely stored in the one or more secure financial databases 152 (which are secure at least in accordance with PCI standards). Accordingly, a user's actual account information may be stored in the one or more secure financial databases 152, while an account ID and a token (corresponding to the information stored in the databases 152) are stored in the databases 114 and are used for the account matching processes discussed herein. Accordingly, in response to the system determining that modifications are to be requested at to a user's banking or credit card accounts (e.g., funds should be transferred or received), the system may transit the appropriate account token to the third-party account services 154 at the third-party financial account services system 116, where the third-party account services 154 may either match the token with the corresponding account information, or the third-party account services 154 may decrypt the token for determining the corresponding account information. Notwithstanding the above discussion of a third-party financial account services system 116, the processes executed and performed by the system 116 may also be executed and performed within the remote account matching system 112.

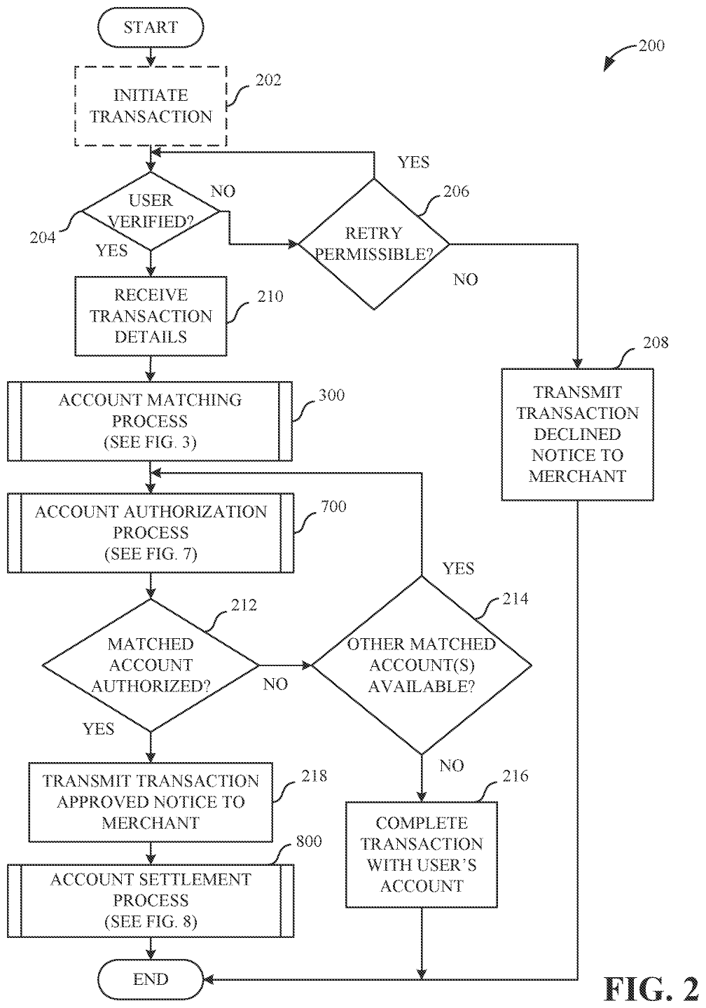

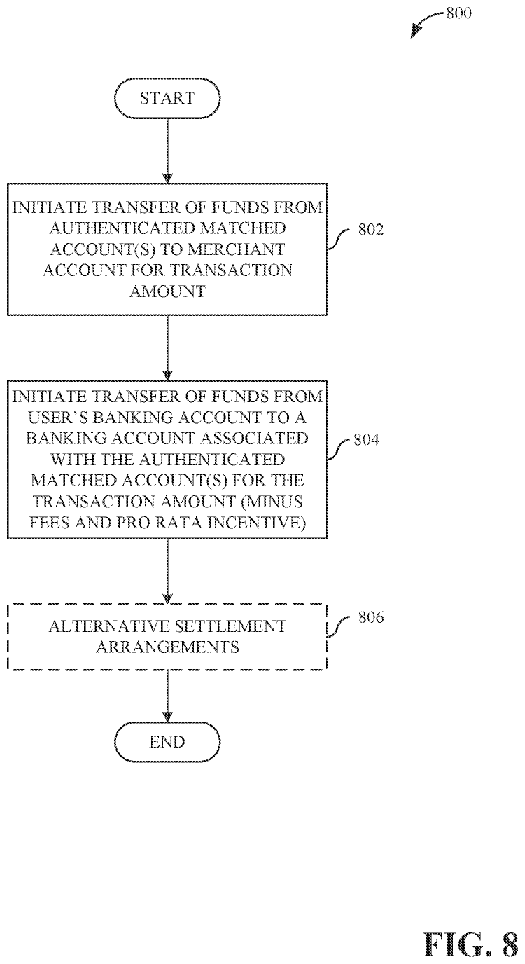

Turning now to FIG. 2, a flowchart of an exemplary system process 200 is shown according to one aspect of the present disclosure. In various embodiments, the process 200 generally illustrates a start-to-finish process by which the system matches a user's financial transaction with a merchant to one or more financial accounts corresponding to pseudo-anonymous users, where the account information corresponding to the one or more financial accounts is used for completing the transaction. In particular embodiments, the one or more financial accounts matched with the user's financial transaction are matched based on one or more financial incentives, benefits, discounts, or advantages available to the financial accounts and (generally) not available to the user via his/her own account. Moreover, the process 200 includes an account settlement process 800 (as will be discussed in greater detail below in association with FIG. 8) that describes processing steps for the user reimbursing the pseudo-anonymous user for use of the matched financial account(s).

In one embodiment, the process 200 begins at step 202 (an optional step), where the user initiates the financial transaction, generally with a merchant. In various embodiments, the step 202 is an optional step because the merchant may sometimes initiate the financial transaction with the user (for example, if the merchant provides the user with a transaction-related code to scan or read via the user's mobile computing device, and Where scanning or reading the code initiates the financial transaction). However, the process 200 nonetheless begins with a user engaging in a financial transaction using a mobile payment application on his/her mobile computing device.

At step 204, according to one aspect of the present disclosure, the system determines if the user is verified to use the mobile application running on the mobile computing device for engaging in a financial transaction. If, at step 204, the system determines that the user is not verified, the process 200 may proceed to step 206 where the system determines if the user is permitted to retry the verification process. For example, if at step 204 the user was unable to be verified given a poor biometric reading, the user may be granted a permissible retry at step 206 (thus returning to the step 204). However, in certain embodiments it may be determined at step 206 that the user is not permitted to reattempt verification (for example, if the user is temporarily blocked from using the application), which may result in the process 200 proceeding to step 208 where the system transmits a “transaction declined” notice to the merchant.

According to various aspects of the present disclosure, if the user is verified to use the application at step 204, the system may subsequently receive transaction details (at step 210) corresponding to the financial transaction in which the user is engaged in with the merchant. In at least one embodiment, the transaction details may first be received by the mobile computing device in response to the mobile computing device scanning a QR code (or a similar visually machine-readable code), where the QR code is proffered by the merchant point-of-sale system and is representative of at least a portion of the financial transaction details (such as the merchant identifier and the purchased goods/services). In particular embodiments, the transaction details may also be received by the mobile computing device in response to the mobile computing device detecting and reading a wireless signal or code, such as a near field communication (NFC) signal (or a similar machine-readable code), where the signal is proffered by the merchant point-of-sale and is representative of at least a portion of the financial transaction details (such as the merchant identifier and the purchased goods/services). According to various aspects of the present disclosure, the mobile computing device includes one or more processors operatively configured to process QR codes and/or NFC signals for determining the content of the encoded messages.

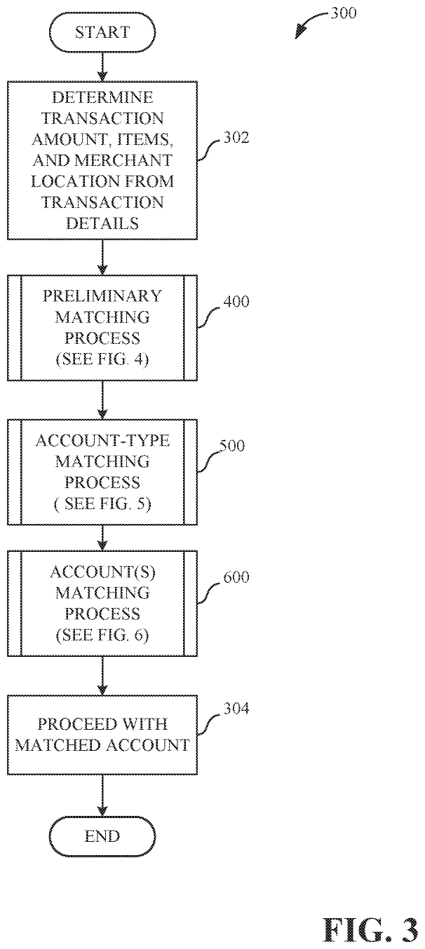

In response to receiving the transaction details at step 210, the process 200 may proceed to a subprocess which corresponds to an overall matching process 300 (as discussed in greater detail below in association with FIG. 3). Moreover, subsequent to the overall matching process 300 is the account authorization process 700. According to various aspects of the present disclosure, the subprocess 300 and 700 generally respectively determine one or more financial accounts that are optimal for matching to the financial transaction engaged in by the user (based on the transaction details received at step 210), and furthermore if the one or more financial accounts are authorized to complete the financial transaction. In one embodiment, if the system determines at step 212 that a matched account is not authorized to complete the financial transaction, the process 200 may proceed to the step 214 where the system further determines if other accounts were identified as available matches. If, at step 214, it is determined that other accounts were identified as available matches, the process 200 returns to the subprocess 700 for performing the authorization process on the other matched account(s). If, at step 214, it is determined that no other accounts were identified as available matches, the process 200 may proceed to the step 216 where the system completes the transaction with the user's own financial account.

In various embodiments, and referring back to step 212, if the system determines that a matched account is authorized to complete the transaction, the system may transmit (at step 218) a notice to the merchant that the financial transaction with the user is approved and complete. Further, and according to various aspects of the present disclosure, given a financial account corresponding to a party (i.e., an anonymous user) not actually present at the merchant point-of-sale system is used to fulfill the transaction with the merchant in lieu of an account corresponding to the user actually engaged in the transaction with the merchant, the system performs a series of steps for transferring funds between the banking accounts associated with the involved financial accounts. This series of steps is referred to herein as the account settlement process 800, which is described in greater detail below in association with the discussion of FIG. 8.

In one embodiment, 3 shows a flowchart illustrating an exemplary general matching process 300. According to various aspects of the present disclosure, the process 300 begins at step 302, where the system determines certain information from the transaction data for proceeding with the matching process 300. In at least one embodiment, the transaction data may include information such as an identifier corresponding to the application user (user ID), a merchant identifier (merchant ID), a merchant location (for example, in embodiments where the merchant location may not be stored in the remote system), a merchant IP address (for example, in virtual embodiments where the merchant storefront is a website, or the like), transaction details (e.g., items purchased, specific SKU's, merchant codes, merchant type, merchant category code (MCC), transaction value amount, etc.). a transaction timestamp, and any other appropriate transaction-related information. In various embodiments, the user ID and the merchant may both be generated and assigned to the user and merchant, respectively, in response to a registration process with the system. In particular embodiments, the merchant ID may be generated and assigned by another entity (for example, by the merchant itself or a payment processing partner or bank associated with the merchant), and the system may only receive the merchant ID as included in the transaction details without storing and/or retaining the merchant ID and corresponding merchant financial account information in the one or more databases 114. According to various aspects of the present disclosure, the registration process may include providing personal information (for users), business information (for merchants), banking or asset account information (for both users and merchants), and other financial account information, such as credit card information (for users), which may be used for matching transactions with the most beneficial/advantageous financial account for fulfilling the transaction. (based on incentives available via the financial account either based on the specific merchant or more generally based on the merchant category code).

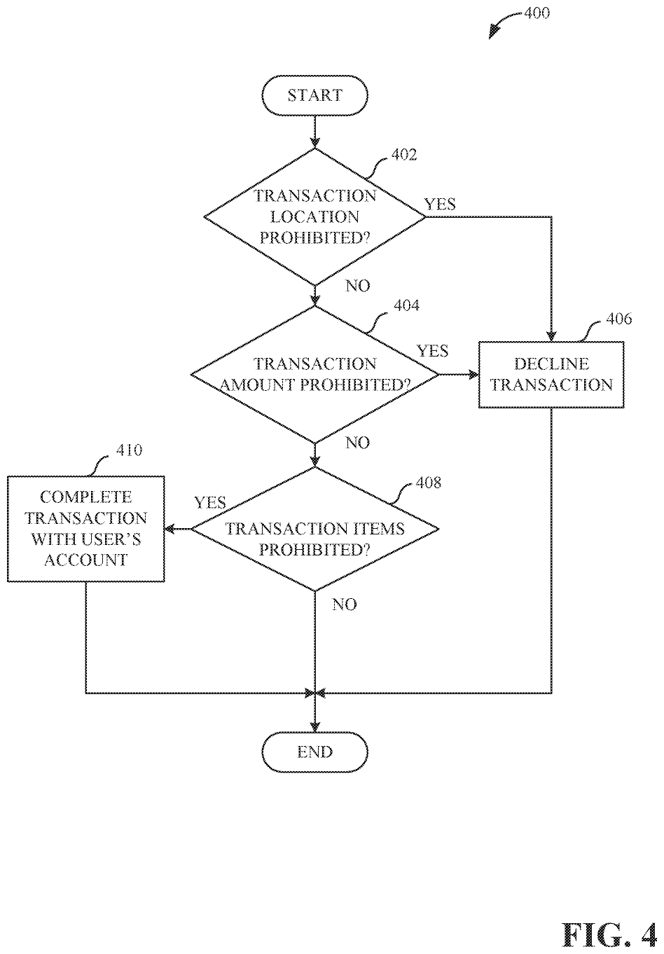

In response processing and/or extracting particular data elements (e.g., user ID, merchant ID, etc.) from the transaction details, the process 300 proceeds to the preliminary matching process 400, which will be discussed in greater detail below in association with the discussion of FIG. 4. According to various aspects of the present disclosure, the preliminary matching process 400 executes a series of process steps for effectively filtering the number of potential accounts which may be candidates for being matched to a financial transaction. In short, the preliminary matching process 400 determines if any baseline requirements for being matched to a financial transaction are satisfied or violated.

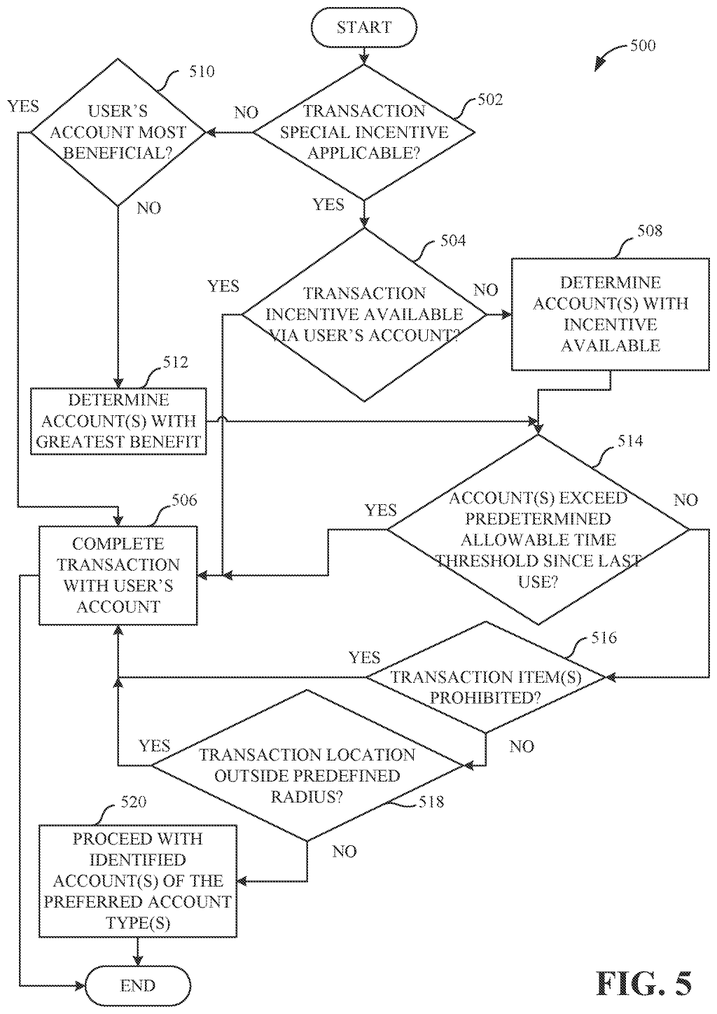

Continuing with the process 300, in response to receiving the result from the process 400 (a list of accounts to potentially match with a financial transaction), the process 300 then proceeds to the account-type matching process 500, which will be discussed in greater detail below in association with the discussion of FIG. 5.

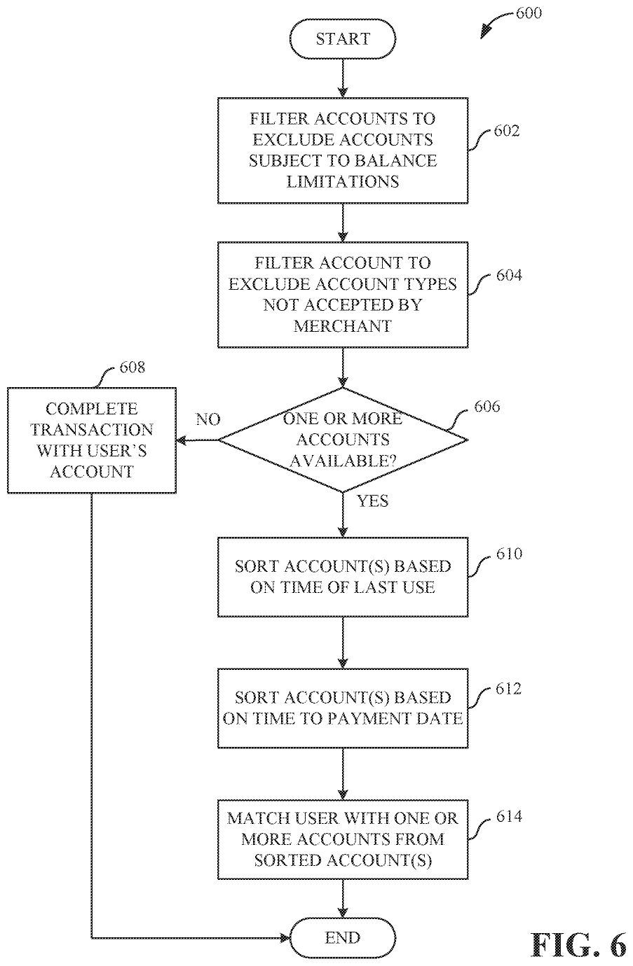

Still continuing with the process 300, in response to receiving the result from the process 500 (a narrowed list of accounts with one or more preferred account type(s)), the process 300 then proceeds to the specific account matching process 600, which will be discussed in greater detail below in association with the discussion of FIG. 6.

According to various aspects of the present disclosure, the result from the process 600 is generally a sorted, filtered, or otherwise prioritized list of one or more financial accounts which the system has determined, via the process 300, are the most advantageous or beneficial financial accounts available to use for a particular financial transaction based at least on applicable account incentives (for example, 6% cash-back at grocery stores, $25 off a purchase of $100 or more at X department store, etc.). Thus, in at least one embodiment, at step 304 the process 300 proceeds with one or more of the matched accounts for potentially fulfilling (or completing) the financial transaction between the user and the merchant.

Turning now to FIG. 4, a flowchart illustrating a preliminary account matching process 400 is shown, according to one embodiment. In various embodiments, the steps of the process 400 determine if the transaction satisfies certain basic attributes generally required (for example, based on expected or well-known reasons for which financial institutions decline transactions) for a transaction to qualify for this procedure. In certain embodiments, these attributes may include, but should not be construed as being limited to, the transaction geographic location, the transaction amount (and an estimate tip upper bound), and the products or services be rendered. Accordingly, the process 400 begins at step 402, where the system determines if the transaction location is prohibited. In one embodiment, the transaction location may be included in the transaction details as received at step 210 of the process 200, as discussed above in association with FIG. 2.

If at step 402, the system determines that the transaction location is prohibited, the process 400 proceeds to step 406 where the transaction is declined. However, if, at step 402, the system determines that the transaction. location is not prohibited, the process 400 may proceed to step 404 where the system determines if the transaction amount is prohibited. Just like at step 402 as discussed above, if the transaction amount is prohibited (at step 404), the process 400 may proceed to step 406 where the system declines the transaction. If the transaction amount is not prohibited at step 404, the process 400 may proceed to step 408 where the system further determines if the transaction items are prohibited. if the transaction. items are determined to be prohibited at step 408, the process 400 may proceed to step 410 where the users own account may be used for completing the transaction. Further, if it is determined at step 408 that the transaction items are not prohibited, the process 400 may terminate and thus return to the process 300.

Referring now to FIG. 5, an exemplary account-type matching process 500 is shown, according to one embodiment of the present disclosure. In one embodiment, the account-type matching process 500 begins at step 502 where the system determines if a special incentive is applicable to the transaction. In one embodiment, various types of financial incentives and/or discounts may be available to transactions made via the system. For example, a special incentive may include a merchant-specific discount, such as a $25 discount if a transaction made with a particular account/card at the merchant exceeds $100. In other embodiments, general incentives and/or discounts may be available according to merchant types (based on merchant codes, or the like). In various embodiments, the system may be operatively connected to one or more external databases (for example, a database operated by the card issuing financial institute) that store and publish those incentives (as incentives may be added, removed, and updated change frequently). In particular embodiments, system users may input one or more incentives that are available via one or more of his/her registered payment cards, which the system may store in a database which includes aggregated user-inputted transaction incentives. Accordingly, in a particular embodiment, if the system determines at step 502 that a special incentive is available (e.g., a merchant-specific incentive), the process 500 may proceed to step 504 where the system further determines if the special and merchant-specific transaction is available for use via the user's account (e.g., a user's credit card account register with the system). If, at step 504, the system determines that the transaction incentive is available via the user's account, the process 500 may proceed to step 506 where the system completes the transaction with the user's account (the user's account included the most financially advantageous incentive/discount). Continuing with step 504, if the system determines that the transaction incentive is not available via the user's account, the process 500 may proceed to step 508 where the system determines the account(s) that can provide the incentive/discount.

Referring back to step 502, if the system instead determines that no special incentive is applicable to the transaction, the process 500 may then proceed to step 510, where the system determines if the user's account already includes the most beneficial or financially advantageous incentive available. If, at step 510, the system determines that the user's account indeed already includes the most beneficial or financially advantageous incentive available, the process 500 proceeds to step 506 where the system completes the transaction with the user's account (for example, the user's account includes a 6% cashback incentive, and all other account incentives include 6% cashback (or less)). If, at step 510, the system determines that the user's account does not include the most beneficial or financially advantageous incentive available, the process 500 proceeds to step 512 where the system determines the one or more financial accounts registered with the system that include the most financially advantageous benefit for the transaction.

In various embodiments, both steps 512 and 508 of the process 500 proceed to the step 514 which includes determining if the account(s) exceed a predetermined allowable time threshold (e.g., 30 seconds, 1 minute, 5 minutes, 10 minutes, 30 minutes, etc.) since the last account use. According to various aspects of the present disclosure, using a single financial account for fulfilling multiple transactions with little or no time in between transactions may result in declined transactions given the underlying payment rails may not be configured to process transactions at such a rapid rate. Thus, in certain embodiments, the system may sort accounts based on time of last use in an effort to minimize declined transactions. Accordingly, if the system determines at step 514 that one or more accounts exceed the allowable predetermined time threshold since last use, the process 500 may proceed to step 506 where the system completes the transaction with the user's account. If the system determines at step 514 that one or more accounts do not exceed the allowable predetermined time threshold since last use, the process 500 may proceed to step 516 for further filtering.

At step 516, in certain embodiments, the system determines if the transaction items are prohibited from purchasing using any of the one or more account(s). In various embodiments, the prohibition of the transaction items (or goods, in some embodiments) may be implemented by the financial account owner (card holder) or one or more financial institutions associated with the financial account. If the system determines, at step 516, that the transaction item(s) are prohibited, the process 500 may proceed to step 506 where the system completes the transaction with the user's account. If the system determines at step 516 that the transaction items are not prohibited (at least by one or more financial accounts), the process 500 may proceed to step 518 where the system determines if the transaction location is outside a predefined radius (e.g., 1 mile, 5 miles, 25 miles, 100 miles, 1000 miles, etc.). If it is determined at step 518 that the transaction location is outside the predefined radius, the process 500 may proceed to step 506 where the system completes the transaction. with the user's account. in at least one embodiment, the system performs the steps 514-518 in order to avoid card payment scenarios that are likely to be declined by the card-issuing financial institutions, such as suspicious scenarios in which credit card details belonging to a Georgia resident are provided for purchasing a refrigerator in Ohio only 10 minutes after the same card details were used for purchasing gasoline in Georgia—which is indicative of a fraudulent transaction. if the system determines, at step 518, that the transaction location is within the predefined radius, the process 500 may proceed to step 520 which includes proceeding with the remaining identified account(s) of the preferred account type(s).

Turning now to FIG. 6, an account matching process 600 is shown, according to one aspect of the present disclosure. According to various aspects of the present disclosure, the process 600 begins at step 602 where the system filters (to exclude from the remaining steps of the matching process) financial accounts that are subject to balance limitations. For example, regardless of whether a particular account is determined during the process 500 to include financially advantageous incentives applicable to a particular transaction, the account may nonetheless be filtered and excluded from the process 600 if the account, for example, does not have sufficient funds/credit available to complete the transaction, or if the account has exceeded other limitations (e.g., weekly transaction limits).

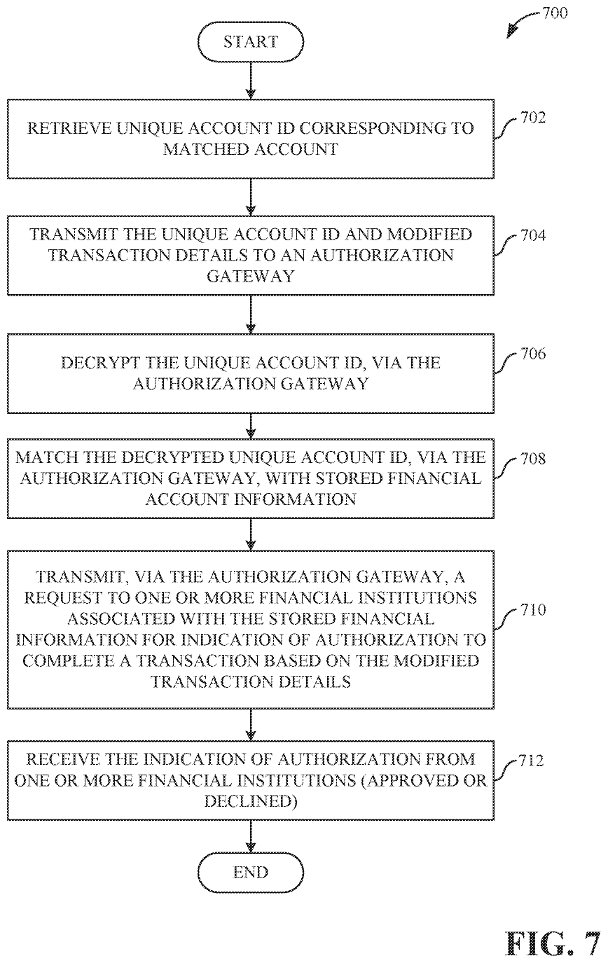

At step 604, in one embodiment, the system continues to filter the accounts to exclude account types not accepted by the merchant. In various embodiments, given merchants are typically charged fees by credit card companies (and/or other financial institutions) for accepting certain credit cards from customers for payment, it is not uncommon for merchants to simply not accept certain credit cards or payment methods with high fees. Thus, in one embodiment, filtering the accounts to exclude account types not accepted by the merchant 604 prevents the scenario in which the most financially advantageous matched card is nonetheless rejected by the merchant or declined (for example, during the authorization process 700, discussed below in association with FIG. 7).

In particular embodiments, at step 606, the system. determines if one or more financial accounts remain in response to the prior filtering steps 602 and 604. If the system determines that no accounts remain to be matched for fulfilling the financial transaction, the process 600 may proceed to step 608 where the system completes the financial transaction with the user's financial account (for example, a credit card associated with the user's mobile computing device 108 or stored within the mobile application). However, at step 606, if the system determines that one or more financial accounts indeed remain to be matched for fulfilling the financial transaction, the process 600 may proceed to step 610 where the system sorts the remaining account(s) based on the time of last use. According to various aspects of the present disclosure, using a single financial account for fulfilling multiple transactions with little or no time in between transactions may result in declined transactions given the underlying payment rails may not be configured to process transactions at such a rapid rate. Thus, in certain embodiments, the system may sort accounts based on time of last use in an effort to minimize declined transactions. In other embodiments, when determining between two or more financial accounts to which the system may match the financial transaction for, the system may be configured to select the account with the most time since its last transactions, given this matching scheme promotes fairness between all potential financial accounts.

Further, the process 600 may proceed to step 612 where the system sorts the remaining account(s) based on a time to account payment date. In various embodiments, given a first financial account with an impending payment date is more likely to have a greater balance than a similar second financial account that is a about a month away from the account payment date, the first financial account is more likely to be declined for insufficient funds. Accordingly, the system may prioritize matching transactions to financial accounts that have ample time until a payment date over match the transactions to financial accounts that have impending payment dates (to reduce the likelihood of authorization denials), or to allow for more time before repayment. Lastly, at step 614, and in response to the filtering and sorting steps discussed above in connection with FIGS. 4-6, the system may match the user's financial transaction with one or more of the accounts from the remaining accounts.

In one embodiment, FIG. 7 is an account authorization process 700. In particular embodiments, notwithstanding identifying a particular financial account (e.g., an account corresponding to a rewards credit card) as being the most financially advantageous financial account for completing a transaction, the identified financial account may need to be authenticated by one or more financial institutions prior to completing the transaction.

According to various aspects of the present disclosure, the account authorization process 700 begins at step 702 where the system retrieves a unique account identifier corresponding to a matched account. It should be understood from the disclosure herein that one or more financial accounts may be identified as a match for fulfilling a financial transaction, and further that more than one financial account may be used for fulfilling the financial transaction; however, for ease of understanding, the process 700 is described as if only a single financial account is identified as a matched account. Accordingly, at step 702, retrieving the unique account identifier corresponding to the matched account includes retrieving the unique account identifier—an encrypted token—from a token database (such as the database 114, or an individual database included in the databases 114). In particular embodiments, the database 114 may be a nonrelational database such that database entries are stored according to key-value pairs. For example, in one embodiment, a matched account (or matched account name, such as Chase Sapphire Reserve) may constitute the key in a key-value pair, and a tokenized representation of the matched account details may constitute the value in the key-value pair.

In particular embodiments, at step 704 the system transmits the unique account identifier and modified transaction details to an authorization gateway, where transaction details are modified based on the format and required data for transmitting API requests to the authorization gateway. In certain embodiments, prior to one or more financial accounts being used to fulfill a. financial transaction, the account(s) may require authorization to fulfill/complete the transaction from the one or more financial institutions responsible for providing the underlying account support. In particular embodiments, the authorization gateway may include the integrations with the financial networks, financial payment gateways, and the like, for routing an authorization request through this financial pipeline (extending from the payment network/gateway to the issuing financial institution). In at least one embodiment, the system may leverage third-party financial services for performing the steps of an authorization gateway. For example, the system may use the Spreedly service, or other similar and appropriate services.

At step 706, in one embodiment, the system decrypts the unique account identifier and furthermore (at step 708) matches the decrypted unique account identifier with stored financial account information. In particular embodiments, the unique account identifier is a token including an encrypted Version of the stored financial account information, and thus decrypting the unique account identifier (in theory) should result in the information matching the stored financial account information. In some embodiments, the system (via the authorization gateway) need not decrypt the unique account ID for identifying matching stored financial account information. Rather, in certain embodiments, the authorization gateway may include a PCI-compliant database (such as the database 152) configured to store the unique account identifier in association with the corresponding financial account information (as a key-pair value). Thus, in this particular embodiment, retrieving the financial account information may simply require a database lookup instead of a decryption process.

In one embodiment, step 710 of the process 700 includes transmitting a request to one or more financial institutions associated with the stored financial account information for authorization. in particular embodiments, the request transmitted at step 710 includes at least the financial account information and elements of the financial transaction data. For example, a request for authorization to complete a transaction may include at least a credit card number, a transaction amount, and a merchant ID. In certain embodiments, the request may also include additional credit card account details such as the account expiration date or the card's CVV. According to various aspects of the present disclosure, the request for authorization may be received by the credit card issuing financial institution (for example, JPMorgan Chase), and the issuing financial institution may return an indication of whether the stored financial account information may be used for completing the transaction.

At step 712, the system receives the indication of authorization from the one or more financial institutions. For example, and as discussed immediately above in the description of step 710, an issuing financial institution corresponding to the financial account may approve or decline authorization for the transaction based at least on the transaction amount. According to various aspects of the present disclosure, in response to receiving an indication of authorization at step 712, the process 700 may end and return the indication of authorization to dependent processes (such as the process 200).

Proceeding now to FIG. 8, an exemplary account settlement process 800 is shown, according to one embodiment of the present disclosure. In at least one embodiment, and in response to one or more financial accounts being identified (or matched) as the most financially beneficial account(s) (for example, a credit card account with one or more merchant incentives or discounts) to complete a financial transaction between a user (the user 106) and a merchant (the merchant 102), and furthermore in response to the identified account(s) being used to fulfill the financial transaction, an account settlement process occurs wherein the account(s) holder is reimbursed by the user.

In one embodiment. the process 800 begins at step 802 where the system initiates payment from the one or more financial accounts that are matched as being optimal account(s) for fulfilling the financial transaction, and further where the account(s) are authenticated for fulfillment of the transaction. In certain embodiments, the system initiates a transfer of funds from the one or more matched accounts to a merchant banking account. in some embodiments, the system may integrate with third-party banking and/or payment processing applications (such as Plaid, Dwolla, Spreedly, etc.) for facilitating the transfer of funds between the one or more matched accounts and the merchant banking account.

At step 804, according to one embodiment, the system initiates a transfer of funds from the user's banking account to a banking account associated with the matched account(s), where the transfer of funds is for a total amount reflective of the transaction amount. In particular embodiments, the transfer of kinds may be for a total amount reflective of the transaction amount minus a portion of the value of the incentive or discount realized by using the matched account(s) for fulfilling the financial transaction. In at least one example embodiment, the system may include an integration with banking payment rails, and thus the system may initiate and process these funds transfers. In other embodiments, the system may leverage third-party financial services, such as Plaid, Dwolla, or another similar banking application, for transferring funds between the user's banking account and a banking account corresponding to the matched account(s).

In one embodiment, at step 806 of the account settlement process 800 the system determines if the accounts are to be settled according to an alternative settlement arrangement. In particular embodiments, the user (for example, via the application GUI presented at his mobile computing device) may request or select for a particular financial transaction between the user and another party (e.g., a merchant) to be subject to alternative settlement arrangements. In these particular embodiments, the other party to the transaction (e.g., the merchant), may receive flat payment as a result of the financial transaction; however, the user and the pseudo-anonymous user associated with the account(s) matched for fulfilling the financial transaction may agree upon repayment terms that are mutually beneficial for both parties. For example, the user engaging in the financial transaction may indicate that the user would prefer to repay the amount of the financial transaction over time. Accordingly, during the account matching process (such as the process 300, generally), the system may include this indicated alternative settlement/repayment preference as an account filtering criterion. In various embodiments, the user may furthermore indicate the repayment term (e.g., 3 months, 6 months, 12 months, 24 months, etc.), the frequency of payments (e.g., once a week, once a month, lumpsum or balloon payments, etc.), interest rates, if the debt is to be secured or remain unsecured, acceptable asset types for repayment (e.g., different fiat currencies, crypto currencies, digital assets, data rights, etc.), and generally any other arrangement that the user may lawfully propose, and the system may include these settlement arrangement preferences in the matching process. In at least one example, the pseudo-anonymous users may also establish alternative settlement arrangement criteria for their one or more accounts, such that the system may match the one or more accounts with financial transactions for which users request alternative settlement arrangements (thus allowing for the pseudo-anonymous users to generate income, for example, by charging interest to other system users for the use of credit lines or other financial instruments).

In various embodiments, the system, based upon certain user preferences, goals, inputs, transaction types, etc., may pair users that request more flexible repayment terms as opposed to the near real-time settlement method described above. The purchasing users that opt into this credit program may be underwritten to determine risk of default and likelihood of debt repayment. In various embodiments, this determination may be made using an amalgamation of data related to existing activity within the system, credit bureau history, social networking data, and other user attributes from third party data sources. In certain embodiments, in order to secure alternative repayment terms, a purchasing user may—at their discretion—allocate utility rights to their data (that resides in a public or private domain) as collateral to a lending entity in the event that they are not able to fulfill their legal obligation to repay. This user data may include, but is not limited to, the following: files (pictures, documents, computer code, etc.), image, likeness, content, ideas, logic, processes, behavior, etc. The lending entity may he determined by the system based upon a number of factors including, but not limited to, the result of underwriting, the yield preferences set by and the activities of a narrowed list of users during the matching process, covenants associated with any credit facilities available to the system.

According to various aspects of the present disclosure, if the purchasing user enters into a credit agreement with the lending entity, the system may produce a legally binding contract between the parties to outline ownership of the collateral in the event that the repayment obligation is not satisfied. In at least one embodiment, the system may determine where any associated collateral intended to secure the debt obligation may reside in escrow until the obligation is repaid or otherwise remedied. In various embodiments, the agreement may define the period of time, if not in perpetuity, for which the lending entity may retain rights to the collateral should the obligation not be repaid. In the event that there are special terms for a specific obligation, these will be captured within the agreement and enforced for the duration of the agreement. Failure to repay the debt may impact the purchasing user's ability to access the system. Similarly, if the purchasing user demonstrates a consistent repayment behavior on debts originated within the system may allow users to access more attractive terms or priority within the matching process. In particular embodiments, these behaviors and interaction with credit products enabled by the system may determine, in part, the matching process described above as a result.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a computer.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a computer to perform one specific function or a group of functions.

Those skilled in the art will understand the features and aspects of a suitable computing environment in which aspects of the disclosure may be implemented. Although not required, some of the embodiments of the claimed inventions may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed invention are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the inventions are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the invention is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed inventions will be readily discernible from the description herein, by those of ordinary skill in the art. Many embodiments and adaptations of the disclosure and claimed inventions other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed inventions. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed inventions. In addition, some steps may be carried out simultaneously, contemporaneously, or in synchronization with other steps.

The embodiments were chosen and described in order to explain the principles of the claimed inventions and their practical application so as to enable others skilled in the art to utilize the inventions and various embodiments and with various modifications as are suited to the particular use contemplated. Alternative embodiments will become apparent to those skilled in the art to which the claimed inventions pertain without departing from their spirit and scope. Accordingly, the scope of the claimed inventions is defined by the appended claims rather than the foregoing description and the exemplary embodiments described therein.

What is claimed is:

1. A method comprising the steps of:
receiving, at a processor at a remote financial transaction matching system, transaction data from a mobile computing device, the mobile computing device running an application and transmitting the transaction data to the remote computing system in response to an application user engaging in a financial transaction with a point of sale system associated with a merchant, wherein the transaction data comprises at least an application user identifier, a merchant identifier, and transaction details, and wherein the transaction data is generated via the mobile computing device in response to the mobile computing device detecting a machine-readable code proffered by the point of sale system, the machine-readable code comprising an encoded representation of at least the merchant identifier and the transaction details;
determining, from a plurality of financial accounts stored in a database at the remote computing system and wherein each financial account of the plurality of financial accounts is associated with a respective pseudo-anonymous system user, a particular optimal financial account to fulfill the financial transaction, wherein the particular optimal financial account is determined based at least on one or more transaction incentives applicable to the financial transaction and available for use via the particular optimal financial account;
determining a unique account identifier corresponding to the particular optimal financial account, wherein the unique account identifier is stored in the database in association with the particular optimal financial account;
determining, via processing the unique account identifier and modified transaction data at an authorization gateway, that the particular optimal financial account is authorized to fulfill the financial transaction;
in response to determining that the particular optimal financial account is authorized to fulfill the financial transaction, transmitting a transaction approval notice to the point of sale system; and
initiating, via transmitting a request to one or more financial institutions responsible for facilitating payments with the particular optimal financial account, a charge to a legitimate account number corresponding to particular optimal financial account for a particular monetary amount to complete the financial transaction with the merchant.

2. The method of claim 1, wherein the request to the one or more financial institutions includes instructions for the particular monetary amount to be routed to a merchant banking account.

3. The method of claim 1, further comprising the steps of:
retrieving, from the database, an encrypted asset account identifier stored in association with the application user identifier;
retrieving, from the database, an encrypted asset account identifier stored in association with the particular optimal financial account;
decrypting (1) the encrypted asset account identifier stored in association with the application user identifier to determine account and routing information corresponding to an asset account belonging to the application user, and (2) the encrypted asset account identifier stored in association with the particular optimal financial account to determine account and routing information corresponding to an asset account belonging to a particular pseudo-anonymous system user associated with the particular optimal financial account; and
transmitting a request to the asset account belonging to the application user, wherein the request comprises instructions for initiating a transfer of a particular value amount owed to be transferred from the asset account belonging to the application user to the asset account belonging to the particular pseudo-anonymous system user, and wherein the particular value amount owed constitutes reimbursement for the application user's use of the particular optimal financial account.

4. The method of claim 3, wherein the particular value amount owed to the asset account belonging to the particular pseudo-anonymous system user comprises a value less than the particular monetary amount to complete the financial transaction with the merchant, wherein the difference comprises a predetermined percentage of a value corresponding to the one or more transaction incentives.

5. The method of claim 1, wherein the unique account identifier associated with the particular optimal financial account comprises a tokenized representation of its legitimate account number.

6. The method of claim 1, wherein the encrypted asset account identifier associated with the particular optimal financial account, and the encrypted asset account identifier associated with the application user identifier, each comprise tokenized representations of the account and routing information corresponding to their respective asset accounts.

7. The method of claim 1, wherein the machine-readable code proffered by the point of sale system comprises a QR code or a near field communication transmission.

8. The method of claim 1, wherein prior to determining the particular optimal financial account, the method further comprises the step of receiving, in response to the application user interacting with an application graphical user interface displayed on the mobile computing device, one or more application user repayment preferences, wherein the one or more application user repayment preferences comprise repayment terms including repayment date, repayment installments, applicable interest rates, and acceptable asset types.

9. A system comprising:
a remote financial transaction matching system comprising a processor and a database, wherein the processor is operatively configured to execute the steps comprising:
receiving, at a processor at a remote financial transaction matching system, transaction data from a mobile computing device, the mobile computing device running an application and transmitting the transaction data to the remote computing system in response to an application user engaging in a financial transaction with a point of sale system associated with a merchant, wherein the transaction data comprises at least an application user identifier, a merchant identifier, and transaction details, and wherein the transaction data is generated via the mobile computing device in response to the mobile computing device detecting a machine-readable code proffered by the point of sale system, the machine-readable code comprising an encoded representation of at least the merchant identifier and the transaction details;
determining, from a plurality of financial accounts stored in a database at the remote computing system and wherein each financial account of the plurality of financial accounts is associated with a respective pseudo-anonymous system user, a particular optimal financial account to fulfill the financial transaction, wherein the particular optimal financial account is determined based at least on one or more transaction incentives applicable to the financial transaction and available for use via the particular optimal financial account;
determining a unique account identifier corresponding to the particular optimal financial account, wherein the unique account identifier is stored in the database in association with the particular optimal financial account;
determining, via processing the unique account identifier and modified transaction data at an authorization gateway, that the particular optimal financial account is authorized to fulfill the financial transaction;
in response to determining that the particular optimal financial account is authorized to fulfill the financial transaction, transmitting a transaction approval notice to the point of sale system; and
initiating, via transmitting a request to one or more financial institutions responsible for facilitating payments with the particular optimal financial account, a charge to a legitimate account number corresponding to particular optimal financial account for a particular monetary amount to complete the financial transaction with the merchant.

10. The system of claim 9, wherein the request to the one or more financial institutions includes instructions for the particular monetary amount to be routed to a merchant banking account.

11. The system of claim 9, wherein the processor is further operatively configured to execute the steps comprising:
retrieving, from the database, an encrypted asset account identifier stored in association with the application user identifier;
retrieving, from the database, an encrypted asset account identifier stored in association with the particular optimal financial account;
decrypting (1) the encrypted asset account identifier stored in association with the application user identifier to determine account and routing information corresponding to an asset account belonging to the application user, and (2) the encrypted asset account identifier stored in association with the particular optimal financial account to determine account and routing information corresponding to an asset account belonging to a particular pseudo-anonymous system user associated with the particular optimal financial account; and
transmitting a request to the asset account belonging to the application user, wherein the request comprises instructions for initiating a transfer of a particular value amount owed to be transferred from the asset account belonging to the application user to the asset account belonging to the particular pseudo-anonymous system user, and wherein the particular value amount owed constitutes reimbursement for the application user's use of the particular optimal financial account.

12. The system of claim 11, wherein the particular value amount owed to the asset account belonging to the particular pseudo-anonymous system user comprises a value less than the particular monetary amount to complete the financial transaction with the merchant, wherein the difference comprises a predetermined percentage of a value corresponding to the one or more transaction incentives.

13. The system of claim 9, wherein the unique account identifier associated with the particular optimal financial account comprises a tokenized representation of its legitimate account number.

14. The system of claim 9, wherein the encrypted asset account identifier associated with the particular optimal financial account, and the encrypted asset account identifier associated with the application user identifier, each comprise tokenized representations of the account and routing information corresponding to their respective asset accounts.

15. The system of claim 9, wherein the machine-readable code proffered by the point of sale system comprises a QR code or a near field communication transmission.

16. The system of claim 9, wherein prior to determining the particular optimal financial account, the processor is further operatively configured to execute the steps comprising receiving, in response to the application user interacting with an application graphical user interface displayed on the mobile computing device, one or more application user repayment preferences, wherein the one or more application user repayment preferences comprise repayment terms including repayment date, repayment installments, applicable interest rates, and acceptable asset types.

17. A tangible, non-transitory, computer-readable medium comprising instructions encoded therein, wherein the instructions, when executed by one or more processors, cause the one or more processors to execute the steps comprising:
receiving, at a processor at a remote financial transaction matching system, transaction data from a mobile computing device, the mobile computing device running an application and transmitting the transaction data to the remote computing system in response to an application user engaging in a financial transaction with a point of sale system associated with a merchant, wherein the transaction data comprises at least an application user identifier, a merchant identifier, and transaction details, and wherein the transaction data is generated via the mobile computing device in response to the mobile computing device detecting a machine-readable code proffered by the point of sale system, the machine-readable code comprising an encoded representation of at least the merchant identifier and the transaction details;
determining, from a plurality of financial accounts stored in a database at the remote computing system and wherein each financial account of the plurality of financial accounts is associated with a respective pseudo-anonymous system user, a particular optimal financial account to fulfill the financial transaction, wherein the particular optimal financial account is determined based at least on one or more transaction incentives applicable to the financial transaction and available for use via the particular optimal financial account;
determining a unique account identifier corresponding to the particular optimal financial account, wherein the unique account identifier is stored in the database in association with the particular optimal financial account;
determining, via processing the unique account identifier and modified transaction data at an authorization gateway, that the particular optimal financial account is authorized to fulfill the financial transaction;
in response to determining that the particular optimal financial account is authorized to fulfill the financial transaction, transmitting a transaction approval notice to the point of sale system; and
initiating, via transmitting a request to one or more financial institutions responsible for facilitating payments with the particular optimal financial account, a charge to a legitimate account number corresponding to particular optimal financial account for a particular monetary amount to complete the financial transaction with the merchant.

18. The tangible, non-transitory, computer-readable medium of claim 17, further comprising instructions encoded therein, wherein the instructions, when executed by one or more processors, further cause the one or more processors to execute the steps comprising:
retrieving, from the database, an encrypted asset account identifier stored in association with the application user identifier;
retrieving, from the database, an encrypted asset account identifier stored in association with the particular optimal financial account;
decrypting (1) the encrypted asset account identifier stored in association with the application user identifier to determine account and routing information corresponding to an asset account belonging to the application user, and (2) the encrypted asset account identifier stored in association with the particular optimal financial account to determine account and routing information corresponding to an asset account belonging to a particular pseudo-anonymous system user associated with the particular optimal financial account; and
transmitting a request to the asset account belonging to the application user, wherein the request comprises instructions for initiating a transfer of a particular value amount owed to be transferred from the asset account belonging to the application user to the asset account belonging to the particular pseudo-anonymous system user, and wherein the particular value amount owed constitutes reimbursement for the application user's use of the particular optimal financial account.

19. The tangible, non-transitory, computer-readable medium of claim 18, wherein the particular value amount owed to the asset account belonging to the particular pseudo-anonymous system user comprises a value less than the particular monetary amount to complete the financial transaction with the merchant, wherein the difference comprises a predetermined percentage of a value corresponding to the one or more transaction incentives.

20. The tangible, non-transitory, computer-readable medium of claim 17, wherein prior to determining the particular optimal financial account, the instructions, when executed by one or more processors, further cause the one or more processors to execute the steps comprising receiving, in response to the application user interacting with an application graphical user interface displayed on the mobile computing device, one or more application user repayment preferences, wherein the one or more application user repayment preferences comprise repayment terms including repayment date, repayment installments, applicable interest rates, and acceptable asset types.
